(19) United States
(12) Patent Application Publication
(10) Pub. No.: US 2008/0244723 A1
(43) Pub. Date: Oct. 2, 2008

(54) Firewall Restriction Using Manifest

(75) Inventors: Eric D. Brewster, Kirkland, WA (US); Steven C. Yee, Renton, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/692,088

(22) Filed: Mar. 27, 2007

(51) Int. Cl. G06F 9/00

(52) U.S. Cl. 726/11

(57) ABSTRACT

Procedures of using manifest restrictions for use in configuring a firewall are described. In an example, an application including manifest defined restrictions for a firewall is executed. The firewall is configured to permit application access, in accordance with the defined restrictions while the application is executing.

### BACKGROUND

While firewalls prevent unauthorized access, legitimate programs may request access through the firewall. In these situations, the firewall is manually reconfigured to permit the desired access. An example of this is when a program requests access to the Internet to download an update from an Internet resource. In order to allow the program access through the firewall, a user “opens-up” a port so the communication can pass through the firewall. This user intervention may be troublesome for novice users, as the program may not function as desired, if the correct port is unavailable for access. In addition, legitimate inbound communications require access through a firewall For instance, a remote access program may require an open port to permit inbound access to resources protected by the firewall.

Once a port is open, the program is permitted access through the port. “Opening-up” a port may permit more access than is desired by the user. For instance, an open port may allow the program additional access to the Internet, beyond that specified for accomplishing the program's desired purpose. In this manner, if an application becomes infected with a computer virus, an open port may be utilized for a nefarious or unintended purpose.

### SUMMARY

Procedures of using manifest restrictions for use in configuring a firewall are described. In an example, an application including manifest defined restrictions for a firewall is executed. The firewall is configured to permit application access, in accordance with the defined restrictions while the application is executing.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 illustrates an environment in an exemplary implementation that may use technologies to implement manifests to configure firewall access.

FIG. 2 is a flow diagram depicting a procedure in an exemplary implementation in which a firewall is configured in accordance with a program manifest, to restrict access while the program is executing.

FIG. 3 is a flow diagram depicting a procedure in an exemplary implementation in which the extent of permitted firewall access is applied from a application manifest.

### DETAILED DESCRIPTION

Overview

Accordingly, techniques are described to configure a firewall for access in accordance with a program manifest. In one or more implementations, a system is discussed in which a computing device and a firewall module are used to permit program access based on firewall settings defined in a program manifest.

In an implementation, a technique is described in which a firewall is configured to restrict or permit access in accordance with program manifest restrictions. The procedure may be applied to inbound or outbound traffic through the firewall. For example, a “signed”, or verified manifest, is used to configure a firewall to permit network access while the program is running. Implementing a program manifest to configure firewall settings may permit program access to the extent intended by the program originator. The present techniques may permit a program access, such as inbound or outbound traffic, while minimizing manual firewall port resetting. Further, the system may reconfigure the firewall module upon termination of the program to limit system accessibility. For instance, upon termination, the firewall module may close a port previously opened to retrieve program updates.

In the following discussion, an exemplary environment is first described that is operable to permit program access based on manifest defined firewall restrictions.

Exemplary Environment

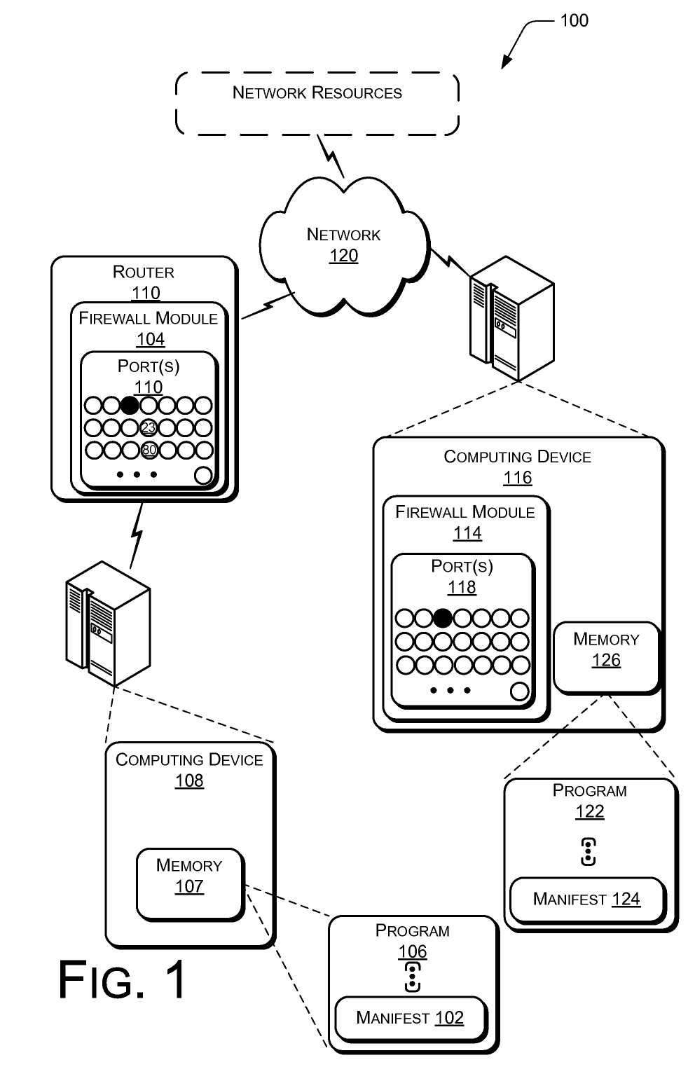

FIG. 1 illustrates an environment 100 in an exemplary implementation that is operable to employ a program manifest 102 to permit communication through a firewall module 104. The permitted access may be based on restrictions included within the program manifest 102. For example, the program manifest 102 may restrict access to a specific port for communication traffic, an extent to which communication is permitted, forbidden packet information, when the communication traffic is allowed, a permitted website, and so on.

The program manifest 102 may be opened when a program 106 is initially executed on the computing device 108. In the present instance, the program is stored in memory 107. The program may be provided in other formats such as on tangible media, as a download, and so on as discussed below. For instance, during initial program 106 execution, the program manifest 102 is accessed in order to set firewall configurations to accommodate the program 106.

For example, a tax calculation application may be configured to access the Internal Revenue Service website to update tax tables when the application is opened. In this situation, the manifest, included in the tax application, may specify what port(s) 110 should be opened; access parameters such as restricting traffic to an official IRS computer when access should occur, and so on.

In a further example, executing a word processing program may result in opening port “80” to permit program updates. The program manifest 102 may additionally include unrelated information such as settings for dynamic link library (DLL) binding, or flagging executables. In this way, the firewall configuration profile may be included as a standard extension in the manifest schema. For inbound traffic, the program manifest 102 (running on the work computer) may permit inbound traffic through a specific firewall port 110, and in accordance with other parameters in a similar manner as the outbound traffic.

While extensible markup language (XML) is primarily discussed, a variety of markup languages may be used where available. Manifest build tools may be updated to accommodate the included firewall definitions.

Upon program 106 termination, the firewall module 104 may be returned to the pre-configuration state. For instance, the firewall module 104 may be restored to the configuration of the firewall without the program manifest 102 applied. If a second program, requesting firewall access was opened, while the original program 106 was running, the firewall may maintain the status of firewall port(s) 110 servicing the second program, while closing a port opened for the first program 106, as well as other firewall configuration changed to accommodate the program 106. Thus, firewall ports 110 may be closed as part of the “closeout” procedure for program 106. If a port is utilized for two or more programs, the port may remain open for the second program.

In the foregoing manner, the configuration defined in the program manifest 102 may persist while the program 106 is active. Thus, the program manifest 102 may define firewall restrictions and permit dynamic firewall reconfiguration based on active program manifests. In this manner manual port opening is minimized, and ports are dynamically closed. Thus, the firewall module 104 may apply restrictions included in the program binary layer at the network layer to block or permit access.

In further implementations, the firewall module 104 is configured to detect attempted firewall access. For instance, the firewall module 104 may be configured to determine if a program 106 is attempting to gain firewall access beyond that which is defined in the program manifest 102. For example, the firewall module 104 may telemetrically determine if a program 106 is exceeding the manifest defined restrictions.

In implementations, the firewall module is configured to report unauthorized firewall access attempts to a website or a networked server in order to address unauthorized access attempts. Further, the website or server may be configured to provide updates (such as a firewall policy update) or alerts in response to access attempts reported by other systems. Thus, if an executable or process is infected with a virus, the firewall may take corrective action as a result of a website update or alert, isolate the program 106, notify the users report the activity to a third party, and so on. For example, a third party website may collect data regarding an attempted access and provide alerts so that other systems may dynamically respond to changing threats.

In further implementations, an interface module may be included for interfacing with the firewall module 104. For instance, if the program manifest 102 is not “signed” the interface module may provide a “pop-up” or a dialog box message which permits a user to allow or block the activity. If, for example, a program 106 is not within the firewall policy, the program 106 may be added to the firewall module policy, if the user selects to allow the firewall access in a dialog box message. In other instances, if a user blocks firewall access, the application may be included in the firewall policy as a “blocked” application. In other examples, the program 106 is permitted access on a “one-time” basis.

While the current discussion has focused on the firewall module 104 included in a router 112, a firewall module may be incorporated into other suitable hardware devices. For instance, the firewall module may be included in a switch, a modem, or hub.

In other implementations, a firewall module 114 is a platform firewall. For example, the firewall module (including ports 118) may be included in a computer 116 which is connected to a network. For example, a personal computer may include a firewall module 114 to control program access with the network 118 or inbound access. In this manner, the firewall module may permit/deny access across the firewall boundary for a program 122 (including a manifest 124) operating on the computer platform. While the program is illustrated as residing in memory 126, the program may be provided to the computer processor in other formats such as in computer readable media such as in a download or on a tangible media. In additional implementations, the firewall is included on a remote computer which functions as an intermediate for firewall access purposes.

In the case of a router including the firewall module 104, the router may act as a gateway between a company intranet or an individual computing device 108 and a network, such as the Internet. For example, the firewall module 104 may be included in router firmware which is implemented to control access between a computer or local area network and a wide area network. The firewall ports 110 may correspond to ports included in the router for transferring data packets.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, for instance, the module, functionality, or logic represents program code that performs specified tasks when executed on a processor (e.g., CPU or CPUs). The program code can be stored in one or more computer readable memory devices, e.g., memory.

The following discussion describes transformation techniques that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks.

Exemplary Procedures

The following discussion describes a methodology that may be implemented utilizing the previously described systems and devices. Aspects of each of the procedures may be implemented in hardware, firmware, or software, or a combination thereof. The procedures are shown as a set of blocks that specify operations performed by one or more devices and are not necessarily limited to the orders shown for performing the operations by the respective blocks. A variety of other examples are also contemplated.

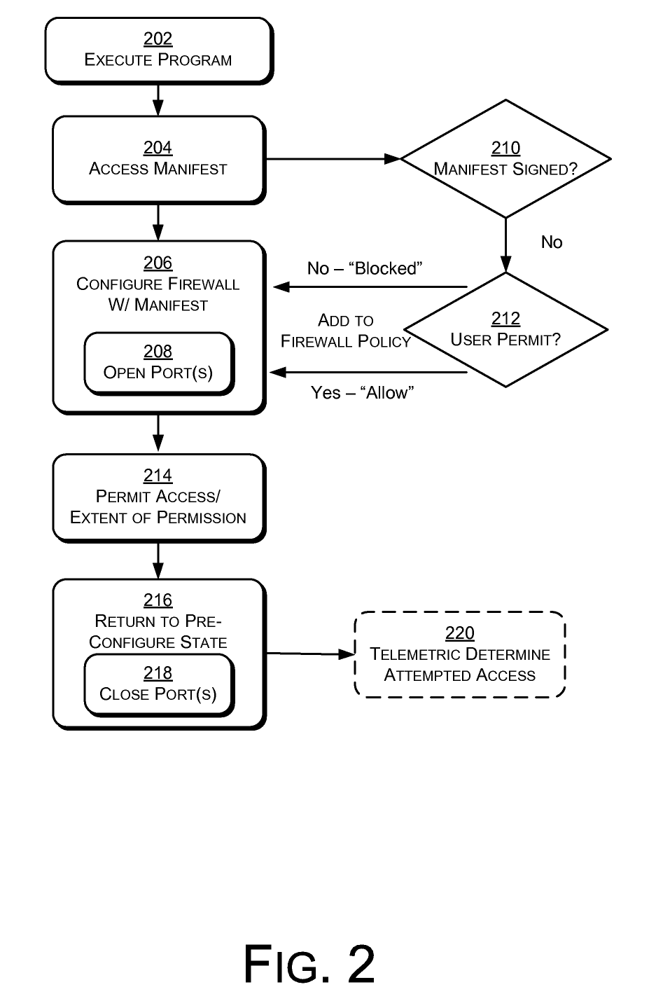

FIG. 2 discloses exemplary procedures for implementing a program manifest for firewall configuration. The firewall may be configured to restrict inbound/outbound communication traffic through the firewall boundary in accordance with the parameters defined in the manifest restrictions.

In the present procedure, execution 202 of a program may result in the computer processor running the program accessing 204 the manifest to determine the firewall restrictions for the program. For example, upon opening a program the processor may access the portion of the manifest defining the desired firewall configuration for the program. For instance, if the program is “signed” or certified by the program author or source, the firewall may be configured 206 to open up a port 208 to allow inbound and/or outbound communication in accordance with the manifest. Determining a “signature” for the program manifest may minimize the potential that the program is infected or that the manifest has been altered to provide firewall boundary access beyond that intended by the program designer. If the program is “unsigned” a user prompt 210 may be generated to allow the user to add the program 212 to the firewall policy to avoid user input or the program may be granted access on a “one time” basis. Adding the program to the firewall policy may result in the program being added as “allowed” or as “blocked.” In the latter case, any request for subsequent firewall access may be denied, as the firewall policy has been updated to reflect the “blocked” status of the program.

If the manifest is “signed” and the manifest restrictions indicate firewall access is permitted, the firewall may be configured 206 to allow access in accordance with the manifest. If, in another case, the manifest was “unsigned”, but user input permitted 212 program access, the firewall may be configured to provide the program access in accordance with the manifest. For example, the firewall is configured to open a port 208 to allow traffic to flow through the port. Other firewall configurations may be configured as well.

In the foregoing manner, the program may be permitted access 214 across the firewall boundary to the extent specified in the manifest with the manifest firewall restrictions being applied on the network level.

Upon terminating the program, the firewall may be returned to a pre-configuration 216 state. This is to say, the configuration of the firewall may be returned to the configuration the firewall would have absent the configurations applied for the program being closed. In this fashion, a port may not be left open for attack when the port is not being used for an active purpose. For example, if a port “23” was opened to accommodate a TELNET program, the port may be closed 218 in response to shutting down the TELNET program on the computer to which inbound access is desired.

Additionally, the procedure may include determining attempted firewall access. For example, a telemetric determination 220 of whether a program is attempting “improper” access may be used to provide a user warning of a potential issue, activate isolation procedures, and so on to prevent or minimize the risk of nefarious or unauthorized access through the firewall. For example, an infected program may attempt to access a remote computer in order to spread the computer virus. In this situation, determining attempted outbound firewall access may result in the program being isolated and the user provided with a warning specifying the program was behaving in a non-standard way, i.e., out of conformance with the restrictions defined in the program manifest. Additionally, the system operating in conformance with the discussed procedures may provide attempted access information to a third party. For example, the access information may be utilized to provide an update or warning to other systems, update firewall configurations, and so on. For example, in response to telemetrically determined attempted access information, a website may update firewall policy information.

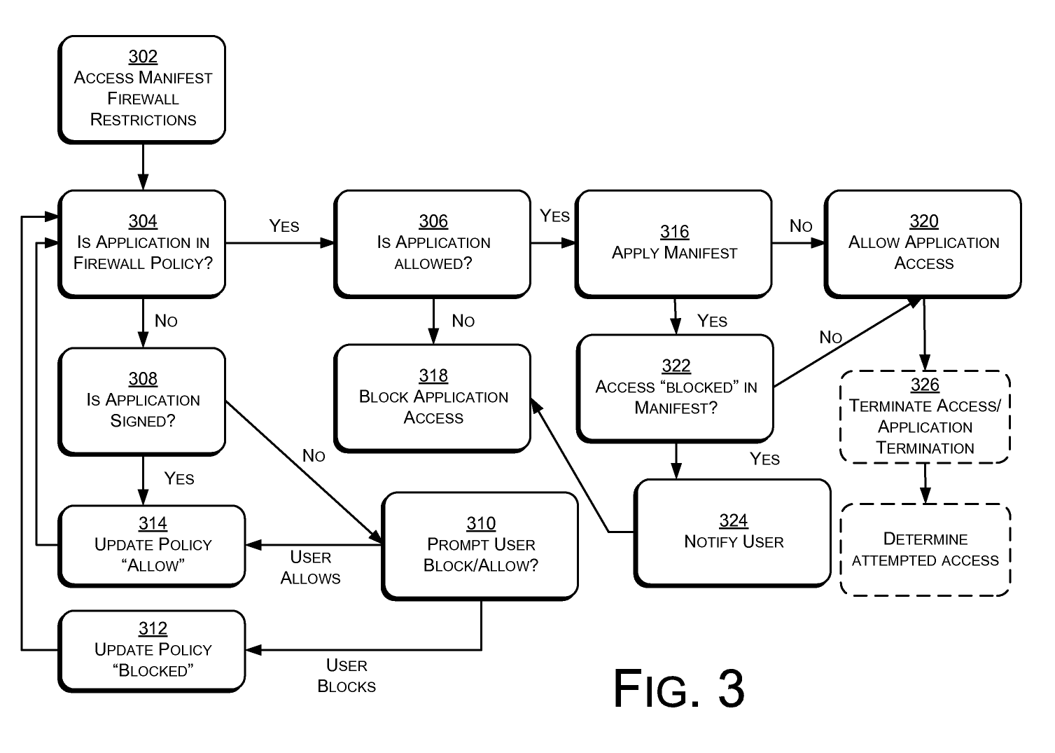

FIG. 3 discloses an exemplary procedure of restricting firewall access in accordance with manifest defined restrictions. Firewall access may include inbound and/or outbound communication traffic. For instance, a word processor application includes a manifest which defines the network access for the application. Including firewall restrictions in the manifest may allow the application to define the firewall restrictions for application in a dynamic manner. The firewall restrictions may be included as a standard extension in the application manifest authored in XML.

For instance, upon “opening” the word processing application, an included manifest may have firewall restrictions included as a standardized extension to restrict application firewall access on the network level. In this case, the manifest may include inbound and/or outbound communication traffic restrictions across the firewall boundary. For example, a manifest may specify that an executable desires access to port “80” at Microsoft.com [a website maintained by Microsoft Corporation, Redmond, Wash. (MICROSOFT is a trademark of the Microsoft Corporation, Redmond, Wash.)] may be authored in XML in the following manner,

```
<?xml version=“1.0” encoding=“UTF-8” ?>
<assembly xmlns=“urn:schemas-microsoft-com:asm.v1”
manifestVersion=“1.0”>
  <trustInfo xmlns=“urn:schemas-microsoft-com:asm.v3”>
    <security>
      <requestedPrivileges>
        <requestedNetworkAccess host=”http://www.microsoft.com”
        port=”80”/>
      </requestedPrivileges>
    </security>
  </trustInfo>
</assembly>
```

In the sample manifest, access to port “80” is requested in line 6. Other markup languages besides XML may be used as well.

As part of the application “opening” initialization, the computer running the application may access 302 the manifest, while the application is running, to determine what firewall restrictions should be applied. In the foregoing case firewall port “80” is opened and the application is allowed to access host “http://www.microsoft.com.”

The application may be checked to determine if the application is included in the firewall policy 304. For example, the application may be checked to determine if the application is known to be “blocked” or “allowed” by the firewall. If the application is included in the firewall policy, the status of the application may be checked to determine 306 if access through the firewall should be granted 316 or the application should be denied access 318.

If the application is “not known” or included in the firewall policy, the manifest also may be checked to determine if the manifest is “signed” 308 or verified by an originator. Checking for an originator “signature” may prevent manifest alterations which would grant the application additional access beyond that which is defined in the firewall restrictions. In this situation, access is restricted to the access intended by the application author or “signor”. If the application is signed the application may be added to the firewall as “blocked” or “allowed.” In further implementations, access may be granted but the application is not added to the firewall policy. If the manifest is “unsigned”, a user prompt 310 may be provided to allow or block access. In the foregoing situation, the user “block” 312 or “allow” 314 input may be used to update the firewall policy. Adding the application to the firewall policy may avoid user input. An “unsigned” application also may be permitted access on “one time” basis. Thus, while firewall access is granted the application is not added to the firewall policy.

The accessed manifest may be applied 316 to configure the firewall to restrict application firewall access, on the network level, to that which is defined in the manifest. For example, a firewall port may be “opened” 320 to allow communication traffic to flow through the firewall boundary or access may be ‘blocked” or denied 322 in the manifest. If access is denied and the application is attempting access across the firewall boundary, a user may be notified 324, the application may be isolated, the application may be closed, access information may be used to telemetrically update other systems, and so on as desired. Other firewall configurations may be applied so that the granted firewall access is constrained. For example, a firewall configuration may include an extent to which the application is permitted to access a network (such as, upon “start-up”), what port(s) are permitted, and so on.

When the application is terminated 326 or “closed”, the firewall configuration may be reset to close firewall access for the application. If, for example, port “80” was opened for a word processing application, then port “80” would be “closed” upon terminating or “closing out” the word processing application. Presuming port “80” does not have another purpose such as remaining open for a system SVCHOST [a generic host process that runs dynamic link libraries (DLL) in MICROSOFT WINDOWS (Microsoft Company, Redmond, Wash.)].

Conclusion

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. A method comprising:
executing a program including a manifest defining firewall restrictions;
configuring a firewall to permit firewall access to the program in accordance with the manifest, while the program is executing.

2. The method as described in claim 1, wherein the manifest is signed by an originator.

3. The method as described in claim 1, further comprising returning the firewall to a pre-configuration state upon closing the program.

4. The method as described in claim 1, wherein the firewall applies the manifest restrictions at a network level.

5. The method as described in claim 1, wherein configuring includes opening a firewall port.

6. The method as described in claim 1, further comprising requesting user input, if the program is not signed.

7. The method as described in claim 6, further comprising adding the program to a firewall policy.

8. The method as described in claim 1, wherein the manifest is authored in extensible markup language.

9. The method as described in claim 1, wherein the manifest defines an extent of program firewall restriction.

10. The method as described in claim 1, wherein the firewall is a platform firewall.

11. One or more computer-readable media comprising computer-executable instructions that, when executed, direct a computing system to,
access an application manifest to determine application firewall access restrictions; and
apply the application network access restrictions to a firewall to permit network access to the extent permitted.

12. The one or more computer-readable media as described in claim 11, further comprising check the manifest for a signature.

13. The one or more computer-readable media as described in claim 11, further comprising closing firewall access upon application termination.

14. The one or more computer-readable media as described in claim 13, further comprising telemetrically determine attempted access.

15. The one or more computer-readable media as described in claim 11, wherein apply the firewall access restrictions includes opening a port.

16. A system comprising:
a computing device including memory to store a program thereon, the program having a manifest defining program network access; and
a firewall module configured to permit program access based on the manifest.

17. The system as described in claim 16, wherein the program performs a task unrelated to firewall module configuration.

18. The system as described in claim 16, wherein the computing device terminates program firewall module access when the program is closed.

19. The system as described in claim 16, wherein the firewall module is embodied in hardware separate from the computing device.

20. The system as described in claim 16, wherein the manifest specifies extent of firewall access.
